(19) United States
(12) Patent Application Publication
(10) Pub. No.: US 2007/0284871 A1
(43) Pub. Date: Dec. 13, 2007

(54) Personalized transactional card and method of use

(76) Inventor: Jeffrey R. Gray, Westport, CT (US)

Correspondence Address: SOFER & HAROUN LLP., 317 MADISON AVENUE, SUITE 910, NEW YORK, NY, 10017, US

(21) Appl. No.: 11/650,853

(22) Filed: Jan. 8, 2007

Related U.S. Application Data
(60) Provisional application No. 60/813,308, filed on Jun. 13, 2006.

(51) Int. Cl. B42D 15/00

(52) U.S. Cl. 283/74

(57) ABSTRACT

A method of personalizing a gift card by a user includes purchasing a blank gift card having no predetermined monetary value, providing a marking implement capable of leaving a permanent mark on the front panel of the card, personalizing the card by releasing a marking ink from the marking implement onto the blank writing surface on the front of the card, and loading the card with a predetermined monetary value. After personalizing the card, the giver presents the loaded personalized gift card to a gift recipient, thereby facilitating a consumer exchange with a vendor when the gift recipient presents the personalized gift card to the vendor.

### RELATED APPLICATIONS

This application is related to and claims the benefit of priority from U.S. Provisional Patent Application No. 60/813308 filed on Jun. 13, 2006, the entirety of which is incorporated herein by reference.

### FIELD OF THE INVENTION

The present invention relates to the field of gift cards, and more particularly to a customizable gift card and a method for personalizing a gift card by a user by marking a permanent mark on the front panel of the card which has a blank writing surface.

### BACKGROUND OF THE INVENTION

U.S. Pat. No. 5,746,451 to Weyer discloses a plastic or paper overlay for the front surfaces of transaction cards. The overlay allows the cardholder to personalize the appearance of the card with a number of designs, ranging from artistic design, to personal photographs, to political, religious, humorous, or other messages. The overlay consists of a thin film of adhesive backed material that adheres to the card. The overlay contains a cut out region and a message region. This reference does not teach a customizable gift card which comprises a front panel with a blank writing surface capable of retaining permanent markings.

U.S. Pat. No. 7,024,807B2 to Street discloses a gift card that is coupled to a greeting card which is purchased as a unit, but may be detached. The purchaser may write a personalized message on the greeting card and enclose it in an envelope together with the attached gift card. This reference does not teach a customizable gift card comprising a front panel with a blank writing surface.

U.S. Patent Application Publication No. 2005/0204600A1 to Lauer et al. discloses a method of personalizing a stored value card by selecting a sticker and applying it to the card. This reference does not teach a method of personalizing a gift card by releasing a marking ink from a marking implement which leaves a permanent mark on the gift card's front panel.

U.S. Pat. No. 6,589,624B1 to Lee discloses a card with removable stickers that can be removed from the card and adhered on any desired position of the card and the card can be written on. This reference does not teach a gift card comprising a front panel with a blank writing surface capable of retaining a permanent mark from a marking implement.

U.S. Patent Application Publication No. 2004/0099730 to Tuchler et al. discloses a method of personalizing gift cards, which includes allowing a customer to upload a customer-specified image onto the internet, download the image from the internet and apply the image to the gift card. This reference does not teach a method of personalizing a gift card by releasing a marking ink from a marking implement onto the card's blank writing surface on its front panel.

U.S. Pat. No. 5,870,718, to Spector discloses a computer-printer internet terminal which produces a composite greeting and gift certificate card redeemable at a retail establishment which authorizes and is paid for the issuance of the certificate. The terminal makes it possible for the user to create and print out a card which carries a message of greeting and a gift certificate from the retail establishment. This reference does not teach a method for personalizing gift cards by releasing a marking ink from a marking implement onto the card's blank writing surface on its front panel.

U.S. Patent Application Publication No. 2003/0160444A1 to Durso discloses personalized phone cards designed to display a person's photograph and personal information while also providing the holder of the card with phone card services. The personalized information is transmitted in a digitized format stored in the server for the computer network and printed out on a phone card. This reference does not teach a method for personalizing gift cards by releasing a marking ink from a marking implement which leaves a permanent mark on the front panel of the gift card.

U.S. Patent Application Publication No. 2004/0049420 to Carlson et al. discloses a gift certificate that is stored onto an electronic storage medium such as but not limited to, a compact disc. The actual storage medium may be personalized by applying a visible message to the outer surface of the storage medium itself. This reference does not teach a gift card with a front panel and a back panel, having a blank writing surface on the front panel.

U.S. Pat. No. 6,682,099B1 to Laurash et al. discloses a gift card and gift card form that permit uniquely messaging each gift card. A gift card form can be printed at a time after manufacturing to allow a vendor to personalize the gift card. This reference does not teach a method for personalizing gift cards by marking the blank writing surface on the front panel of the card.

### SUMMARY OF INVENTION

A transaction card, such as but not limited to, credit, debit, store value, travelers check, or phone cards, may be given as a gift from one person to another. This card, when given as a gift, alleviates the stresses associated with the traditional method of gift giving which usually requires shopping and choosing the appropriate item. The giver must expend time and energy analyzing what the recipient may need or desire. This entails traveling to multiple stores, strolling down a number of aisles, and soliciting others for gift ideas. This is a time consuming process. Furthermore, even after the giver has purchased a gift, he may still fail in the eyes of the recipient, for the gift may be viewed as another item to return to the store.

A gift card, however, allows the giver to assign a monetary value to the card thereby allowing the recipient to buy the gift of his choice. This minimizes the time spent on the gifting process and the hassle that accompanies conventional gift giving. The giver always succeeds in pleasing the recipient since it is the recipient who truly knows what he desires.

However, one disadvantage to the gift card method is that it lacks personal sentiment. The giver has not put much time or thought into the gift rather he/she chose to give a generic gift, devoid of any personal connection.

Additionally, if the giver wishes to include warm wishes with the gift card, he must buy a greeting card in addition to the gift card. Selecting and purchasing a greeting card presents an additional cost and requires additional time and effort.

The object of this invention is to infuse emotional and personal content into a generic gift. A method for personalizing a nonspecific standard gift card is disclosed. The invention relates to a transaction card containing an area that may be personalized by the card purchaser or the card holder.

Another objective of this invention is to remove the need for a greeting card, thereby alleviating the cost and bother of buying a separate greeting card for personal effect. The invention permits one to share his words of greeting by inscribing them on the gift card itself. This minimizes the steps involved in the gifting process.

This personalized area, which can be on the front, back, or both sides of the card, could consist of a blank or shaded area, or a band on the card having a material upon which the user can write or print a personalized message, drawing, etc. The card will still be used for credit, debit, gift, travelers check, or other payment purposes, while including in addition a personal section on which the user can create his or her own personal messages and adornments.

The personalized area of the present invention can be in any number of shapes, and consist of a number of materials facilitating press on lettering, raised lettering, written instruments including markers, pen, pencil, and the like. The gift card can also have multiple personalized areas on one or both sides of the card.

The present invention can be sold as the customizable gift card individually or with the materials for personalization, such as pens, markers, stickers, or stamps/stamp pads.

### BRIEF DESCRIPTION OF THE DRAWINGS

FIG. 1 is a front view of the personalized payment card of the present invention and an accompanying writing implement;

FIG. 2 is a reverse view of the personalized payment card of the present invention;

FIG. 3 is a front view of a second embodiment of the present invention;

FIG. 4 is a front view of a third embodiment of the present invention; and

FIG. 5 is a flow chart showing a method of personalizing and using the payment card as shown in FIG. 1.

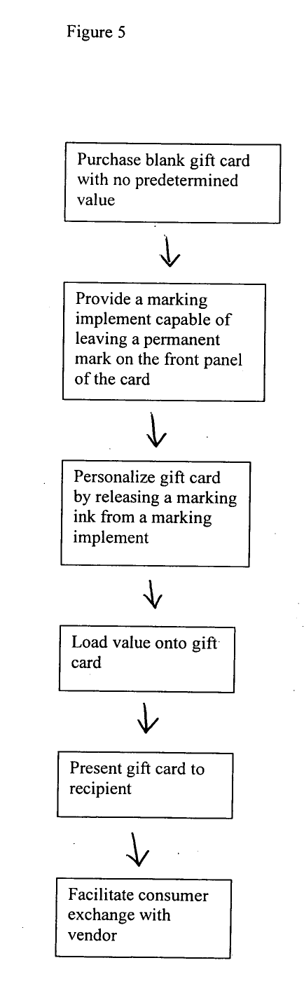

### DETAILED DESCRIPTION

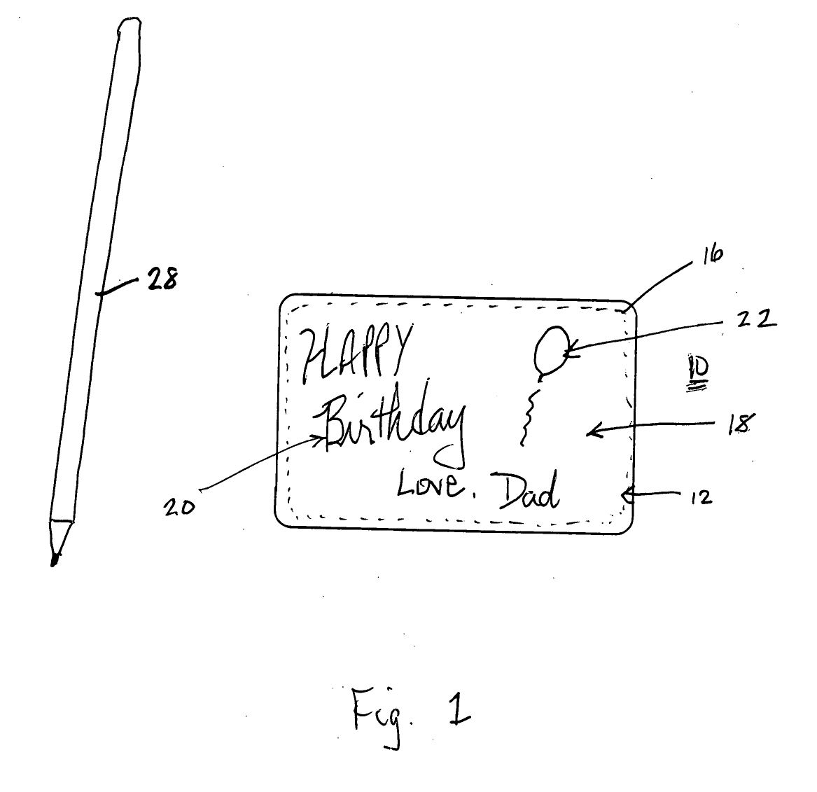

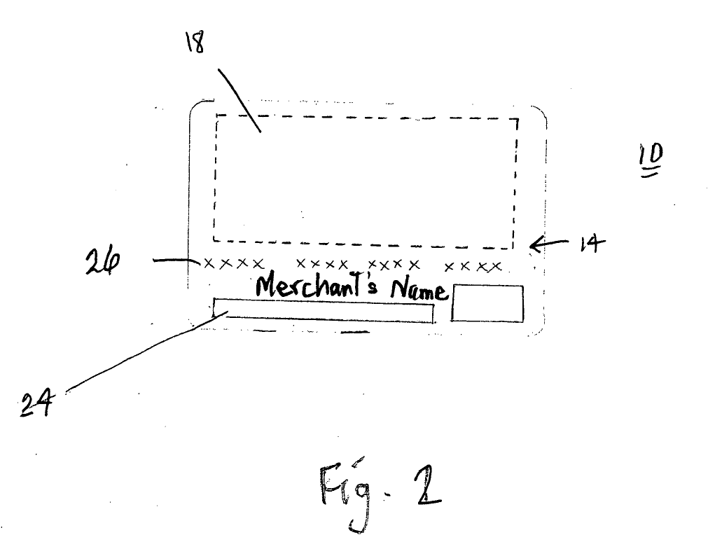

FIGS. 1-2 illustrate a personalized financial transaction card or gift card according to the present invention. The embodiment shown in FIGS. 1-2 includes a card 10 with a front side 12 and a back side 14. Card 10 is typically made out of plastic or hard paper. The plastic can be hard plastic or a softer plastic that is relatively stiff but bendable and/or flexible. Other materials are also contemplated. The card body 16 is sized to be similar to credit cards and debit cards and can be stored in a wallet or a purse. Card 10 can be, for example, a card used by a merchant to issue a spending credit to a customer. The merchant provides the card in exchange for money received, merchandise returned or other consideration. Card 10 is loaded with monetary value that the merchant's customer can use or give to another individual.

Stored value cards and other financial transaction cards come in many forms, according to the embodiments of the invention. A gift card, for example, includes pre-loaded monetary value. In one example, a customer provides consideration in the amount of the card value, or is offered the gift card as an incentive to make a purchase, and then either keeps the card for use or provides the card as a gift to a recipient. The gift card, like other stored value cards can be re-loaded. The balance associated with the gift card declines as the card is used. The card remains in the user's purse or wallet, serving as an advertisement, or reminder to revisit the associated merchant. Gift cards according to the embodiments of this invention provide a number of advantages to both the customer and the merchant.

Other stored value cards according to embodiments of the invention include, merchandise return cards; pre-paid cards, such as phone cards; and other types of cards associated with or representing purchasing power or monetary value. Other forms of financial transaction cards according to embodiments of the invention include credit cards and debit cards.

Front side 12 of card 10 provides a writing surface 18 within card body 16. In one embodiment, writing surface 18 can be a blank area. In other embodiments as shown in FIGS. 2, 3 and 4, writing surface 18 can be a shaded area, or a band on the card. Writing surface 18 may also be provided with a coating upon which the user can write a personalized message or adorn the card with a drawing. Card 10 may be personalized by applying a visual message 20 or picture 22 to writing surface 18 of card 10. In one embodiment, as shown in FIG. 2, back side 14 of card 10 contains a coded portion 24 with coded information as well as numeric information 26 to identify the card by the issuer. FIG. 2 presents an embodiment of the invention having writing surface 18 on back side 14 of the card. Other embodiments have writing surface 18 on both sides of the card.

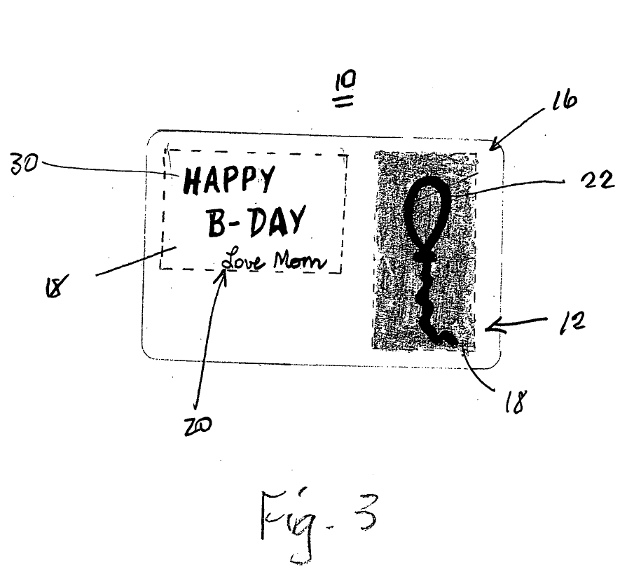

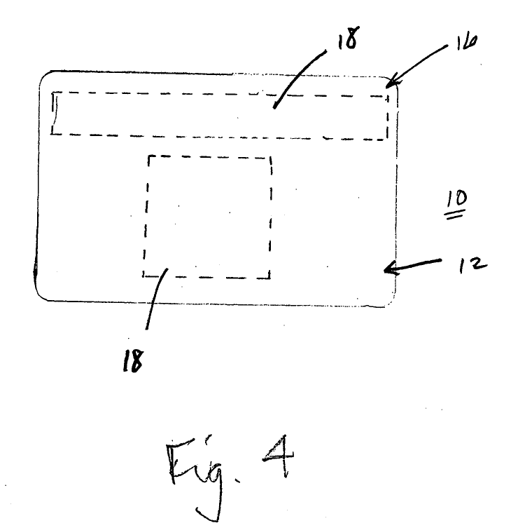

FIGS. 3 and 4 present further embodiments of the present invention wherein card 10 has multiple writing surfaces 18. Writing surface 18 can be in any number of shapes and sizes. In one embodiment it can cover the entire face of the front side of the card as shown in FIG. 1. While in another embodiment, writing surface 18 may consist of a small strip.

Writing surface 18 can consist of a number of materials facilitating press on lettering, raised lettering, writing instruments including markers, pens, pencils, and the like. Card 10 may be coated with a matted surface or a coating that allows for an ink impregnable surface or may be manufactured with a coarse surface suitable for writing instead of the shiny surface found on most gift cards. The writing surface is thus personalized when the marking material is released upon direct contact between writing implement 28 and writing surface 18. Writing implement 28 can be a marker such as Sharpie brand marker or another type of permanent ink marker. FIG. 3 illustrates another embodiment of the invention wherein, writing surface 18 holds stickers 30 and raised lettering 32.

In one embodiment, the invention can be sold individually as a personalized payment card 10. In another embodiment, the invention can be sold as a kit and contain materials for personalization on writing surface 18, such as pens, markers, stickers 30, raised lettering 32 and stamps.

According to a method of the invention, a method of personalizing card 10 comprises providing card 10 with front side 12 and back side 14, as well as permanent writing implement 28. For example, a gift giver desires to purchase a birthday present for a recipient but does not know what the recipient wants or what size will fit correctly. The gift giver first purchases a blank, no value, gift card and writing implement from a first retail outlet without having to purchase a separate birthday card. The gift giver then takes card 10 home and personalizes it with marking implement 28 or in any way set forth by the present invention. Thereafter, the gift giver may go to a favorite store that the recipient may like and load a monetary value into the card. Alternatively, the gift giver may load value on blank card 10, and then personalize the card with marking implements as set forth by the invention.

Once loaded, the gift giver presents the value added personalized gift card to the recipient without having to purchase a separate birthday card and without the risk of having the card being detached from the gift. In this way, card 10, which is provided with a predetermined value as determined by a vendor or retailer and contains writing surface 18, may be personalized utilizing ink impregnable by writing implement 28 with the gift giver's name and desired message. Accordingly, the user releases the permanent marking ink from writing implement 28 onto writing surface 18 thereby leaving a permanent mark on card 10.

In another embodiment, front side 12 is coated with a coating so that marking ink from writing implement 28 may be released throughout the entire surface of gift card 10. In another embodiment, stickers, stamps, raised lettering and the like may also be applied by the user to writing surface 18 for personalization, the writing surface 18 being either coated or non-coated. In this way, when the consumer presents the personalized gift card to the vendor, the consumer facilitates a consumer exchange by purchasing a desired item from the vendor's inventory and wherein vendor debts the cost of the desired item from the personalized gift card.

Thus, a novel transaction card that allows a cardholder to independently customize the card has been presented. Although the invention has been described with respect to particular embodiments, such embodiments are for illustrative purposes only and should not be considered to limit the invention.

What is claimed:

1. A method for personalizing a gift card by a user comprising the steps of:
purchasing a blank gift card having no predetermined monetary value;
providing a marking implement capable of leaving a permanent mark on the front panel of said gift card;
personalizing said blank gift card which comprises a front panel and a back panel, wherein said front panel is provided with a blank writing surface, by releasing a marking ink from said marking implement thereby leaving a permanent mark on the front panel of said gift card, thus allowing the user to customize the front panel of said gift card;
loading said personalized gift card with a predetermined monetary value;
presenting said loaded personalized gift card to a gift recipient; and
facilitating a consumer exchange with a vendor, wherein the gift recipient presents the personalized gift card to the vendor.

2. The method of claim 1, wherein in said purchasing a blank gift card step, said front panel of said gift card is said blank writing surface.

3. The method of claim 2, wherein in said personalizing step, marking ink from said marking implement may be released throughout the entire front surface of said gift card.

4. The method of claim 1 wherein in said purchasing a blank gift card step, said back panel contains a coded portion with coded information thereon.

5. The method of claim 1, wherein in said purchasing a blank gift card step, said front panel is coated with a coating so that marking ink from said marking implement may be released throughout the entire surface of said gift card.

6. A method for personalizing a gift card by a user comprising the steps of:
purchasing a blank gift card having no predetermined monetary value;
providing a marking implement capable of leaving a permanent mark on the front panel of said gift card;
loading said gift card with a predetermined value;
personalizing said blank gift card which comprises a front panel and a back panel, wherein said front panel is provided with a blank writing surface, by releasing a marking ink from said marking implement thereby leaving a permanent mark on the front panel of said gift card, thus allowing the user to customize the front panel of said gift card;
presenting said loaded personalized gift card to a gift recipient; and
facilitating a consumer exchange with a vendor, when the gift recipient presents the personalized gift card to the vendor.

7. A customizable gift card kit comprising:
a transaction card having front and back sides wherein said front side is provided with a customizable blank writing surface;
a marking implement capable of leaving a permanent mark on the front side of said transaction card, and on said customizable blank surface, when marking ink from said marking implement is released onto said front side of said transaction card, so that a user may personalize the front side of said transaction card.
